(19) United States
(12) Patent Application Publication
(10) Pub. No.: US 2008/0167949 A1
(43) Pub. Date: Jul. 10, 2008

(54) Method and technique for media evaluation and comparing personalities

(76) Inventors: Thomas F. Juliano, Baltimore, MD (US); Peter A. Konopka, Huntley, IL (US); Tyler D. Krus, Baltimore, MD (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(21) Appl. No.: 12/002,255

(22) Filed: Dec. 14, 2007

Related U.S. Application Data
(60) Provisional application No. 60/874,704, filed on Dec. 14, 2006.

(51) Int. Cl. G06Q 10/00

(52) U.S. Cl. 705/10

(57) ABSTRACT

A method by which media presented to consumers can be evaluated for efficacy and likelihood of success in the market place. The method consists of calculating the media selection percentage of a given medium presented to consumers and utilizing the calculated media selection percentage in evaluating the likelihood of success of similar medium in the market place. Companies may utilize the media selection percentage to select the most effective media for their products. The media's selection percentage can also be used to connect people with similar interests as a social networking tool. Individuals that select the same medium are likely to be interested in similar activities, products, or lifestyles. As a result, individuals that select similar media have similar interests upon which to build a network.

### CROSS-REFERENCE TO RELATED APPLICATION

This application is based upon and claims benefit of copending and co-owned U.S. Provisional Patent Application Ser. No. 60/874,704, filed with the U.S. Patent and Trademark Office on Dec. 14, 2006, by the inventors herein and titled “Method and Technique for Media Evaluation and Comparing Personalities;” the specification of which is incorporated herein by reference in its entirety.

### BACKGROUND OF THE INVENTION

1. Field of the Invention

This invention relates generally to a method of evaluating media presented to consumers. Specifically, the invention relates to a method for selecting products, services, or marketing materials based on individual's selections and developing social networks.

2. Background

Companies have a vested interest in successful marketing campaigns. As a result, companies invest large amounts of money on developing marketing materials for their products. At the heart of the marketing effort is the ability to attract potential customers and, as a result, marketing materials are constantly being tested for efficacy. A number of methods exist to evaluate marketing materials and products from a company. For the most part, these methods ask individual evaluators to rate the marketing material or product on a relative scale of 1 to 10, hot or cold, and other similar comparison schemes. These methods, however, are not always accurate to demonstrate whether the marketing material or product actually affects a consumer's perception of the product or medium presented to them. As a result, there is a need for a more accurate indicator of consumer sentiment.

The same information obtained for evaluating consumers' preferences for specific marketing materials or products can be utilized to create groups of consumers with similar interests and as a social networking tool. For example, matching services attempt to identify and bring together people that the matching service believes can enter into a successful relationship. These services identify matches by providing questionnaires that allow them to match people with similar interests, beliefs, and/or lifestyles. The provided questionnaires are often burdensome and rely on the individual's answers to specific questions. It would be advantageous to develop a method for evaluating individual's interests in a reliable manner and match those individuals with other people of similar inclinations.

### SUMMARY OF THE INVENTION

The present invention provides a method by which media presented to consumers can be evaluated for efficacy and likelihood of success in the market place. The method consists of calculating the media selection percentage of a given medium presented to consumers alongside other media and utilizing the calculated media selection percentage in evaluating the likelihood of success of similar media in the market place. Companies may utilize the media selection percentage to select the most effective media for their products.

A further object of the present invention contemplates the use of the media's selection percentage to connect people with similar interests as a social networking tool. Individuals that select the same medium are likely to be interested in similar activities, products, or lifestyles. As a result, individuals that select similar media have similar interests upon which to build a network. Other and additional objects of this invention will become apparent from a consideration of this entire specification.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 is a block diagram of the method of evaluating media by an individual.

FIG. 2 is a block diagram of the method of evaluating media used by multiple individuals.

FIG. 3 is an illustration of media displayed to an individual for selection utilizing the method of the present invention.

FIG. 4 is a block diagram of the method of evaluating media for marketing, ranking, and social networking.

FIG. 5 is a schematic illustration of a main page of a web application of the method of the present invention.

FIG. 6 is a schematic illustration of the sign up page of a web application of the method of the present invention.

FIG. 7 is a schematic illustration of the member's page of a web application of the method of the present invention.

### DETAILED DESCRIPTION

The invention summarized above and defined by the enumerated claims may be better understood by referring to the following description, which should be read in conjunction with the accompanying drawings in which like reference numbers are used for like parts. This description of an embodiment, set out below to enable one to build and use an implementation of the invention, is not intended to limit the invention, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

The present invention allows individuals, groups of individuals, organizations, corporations, companies and other entities to evaluate media that they or somebody else has created. The media may consist of elements such as words, phrases, sentences, photographs, paintings, computer generated graphics, manually drawn graphics, video, and sound clips. The media may represent a marketing material, a product, or any other symbol or item to be tested. It is contemplated that in some embodiments of the present invention, the evaluation of media may be accomplished over the internet. It is also possible to practice the present invention as a stand-alone product in a computer terminal, in a network utilized by a number of users or in any other interface that allows an individual to evaluate media presented to him or her.

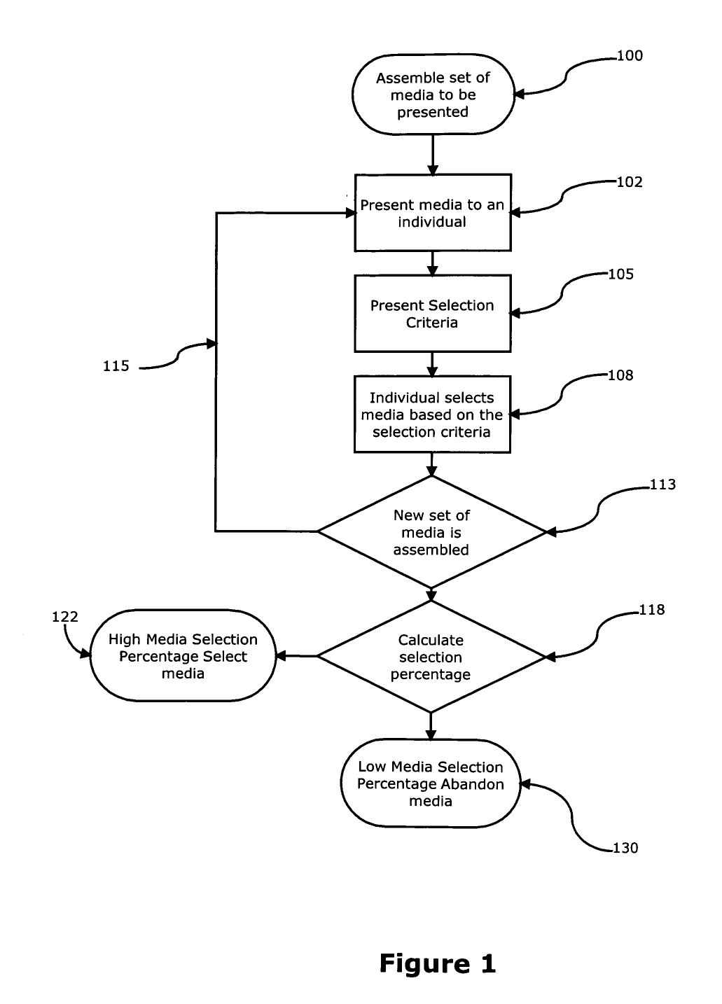

As presented in FIG. 1, one embodiment of the present invention contemplates a method for evaluation of media based on a particular individual's response when given specific selection criteria. In step 100, a set of media is assembled. The set of media may be comprised of a number of elements. Each element corresponds to one specific medium. For example, each element may be a separate graphic or picture. In some instances, an individual, organization, or company may provide only one element to be evaluated and the other elements may be randomly selected from an available library of media. In other instances, the individual, organization, or company may be interested in comparing different elements. In such case, the elements provided by the individual, organization or company would constitute the set of media. It is contemplated that the arrangement of the elements that are utilized for a given set of media may be selected in a random or non-random fashion.

In the next step 102, the set of media is provided to an individual who is presented with selection criteria 105. It is contemplated that in certain embodiments of the present invention, the selection criteria may be presented to the individual before or at the same time the media is presented to the evaluator. The selection criteria may include general preference; non-preference; elicitation of a particular feeling, such as hunger, anger, trust, honesty, happiness, excitement, fear or any other criteria for selection as desired by the individual, organization, or company desiring to test the medium. In the following step 108, the individual selects the media that best fits the selection criteria provided.

Following the selection step 108, it is contemplated that a new set of media 113 is prepared and presented 115 to the individual. The new set of media may include the same or different elements and the first set of media evaluated. It is contemplated that the process may continue for a number of iterations as desired by the evaluator or the individual, organization or company who desires evaluation of the media. Once all the media sets have been evaluated or the individual selects to discontinue, a media selection percentage is calculated 118. The media selection percentage 118 is calculated by comparing the number of times the media is selected with the total number of times that the media is presented to the individual. The higher the selection percentage, the more successful the particular medium is likely to be. The media selection percentage may then be utilized to determine whether the medium being evaluated should be utilized 122 or abandoned 130.

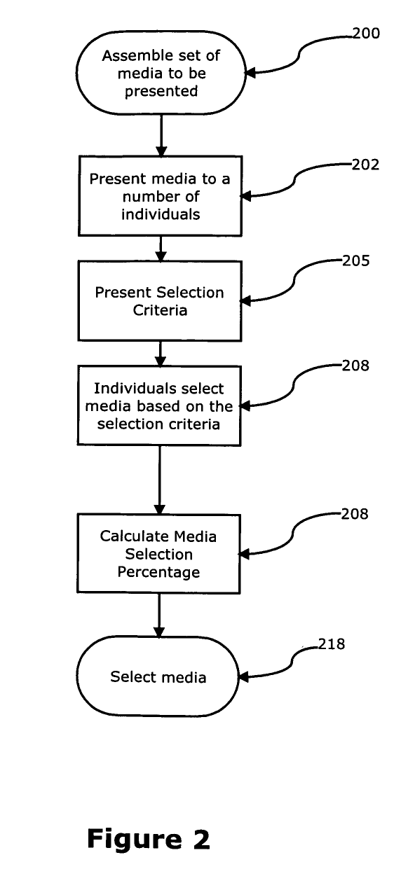

In a further embodiment of the present invention as shown on FIG. 2, the method may be utilized to determine the media selection percentage corresponding to the number of times the media is selected by different individuals. In order to determine the media selection percentage in this fashion, a set of media is assembled 200 including the media to be evaluated and other media selected either randomly or non-randomly as described previously. The set is presented to multiple individuals separately 202 and each individual is given criteria 205 to select the media as described previously. Each individual selects the media that, in his or her opinion, best fits the criteria 208. The media selection percentage 210 is calculated corresponding to the number of times the media is selected compared to the total number of individuals that were presented with the media set and/or the number of times the media set was presented.

In some embodiments of the present invention, it is possible to determine the media selection percentage for a category based upon the number of times the media is selected when compared to the number of times the media is presented to individuals of a specified category. For example, the media selection percentage for males may be determined by the number of times male participants selected the media compared to the total number of times the media was presented to male participants. In another embodiment of the present invention, evaluator selections can be compared against one another or as part of groups. For example, media selection percentages of different groups with common characteristics such as gender, race, age, and others contemplated by one of ordinary skill in the art may be compared against one another to determine differences in interests for those specific groups.

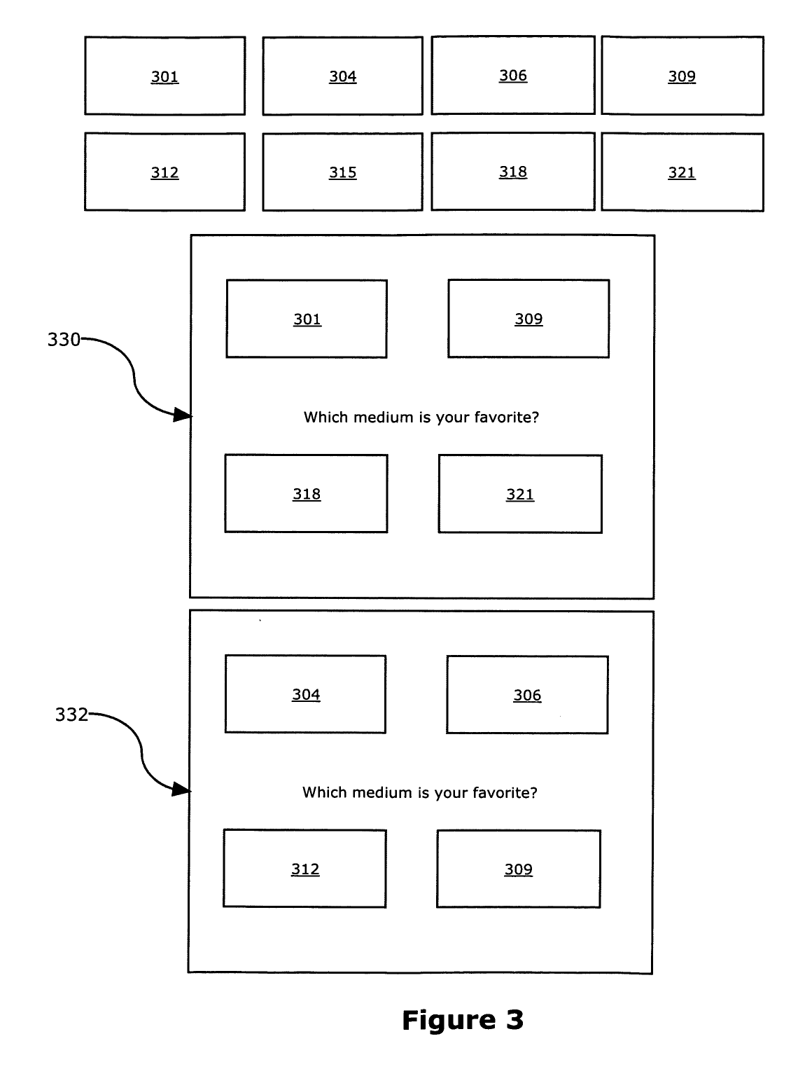

In one example of the present invention as shown on FIG. 3, the media may consist of eight pictures numbered 301, 304, 306, 309, 312, 315, 318, and 321. In this example, medium 309 is being tested and presented to two individuals to determine the media selection percentage. Two sets of media may be randomly generated such that one set 330 may include pictures 301, 309, 318, and 321 and another set 332 may include pictures 304, 306, 312 and 309. Set 330 may be presented to one individual and set 332 may be presented to a second individual through a user interface. It is contemplated that the sets may be presented through any interface contemplated by one skilled in the art, such as computer screens, cellular phone screens, television screens, touch screens and the like. In this case the evaluation criteria is the preferred picture and the media selection percentage is calculated as the number of times the picture is selected among other generated selections compared to the number of times the picture is presented to the individuals.

In another embodiment of the present invention, the individuals are presented with the same set of pictures 304, 306, 312 and 309. It is contemplated that the individuals, in other embodiments of the present invention, may make multiple selections. The selection process may be between any number of media. Furthermore, the individuals may rank the selections based on specified criteria, such as order of preference. Individuals may select media based on the medium that solicits a specific feeling such as hunger or sadness. An additional embodiment contemplates presenting the sets of media multiple times until each individual has reviewed all available media. In addition, the selection criteria may be reported based on demographics such as age, gender, race, ethnicity, and other criteria as understood by one of skill in the art.

It is contemplated that the present invention may be utilized by companies for many different uses, such as choosing a logo for a product or service; choosing a slogan or name for a product or service; choosing a song or sound byte for a product or service; choosing a video clip for a product or service; choosing a marketing or election campaign theme; in psychological research or evaluation of individuals; choosing graphics for store fronts and signs; selecting the area of a screen from which a user is most likely to select media; selecting advertisements to be placed on billboards, the internet, magazines, radio or television; evaluating public affinity to certain symbols; selecting certain geometric features on a building; selecting preferred locations for advertising on buildings; choosing promotional materials; analyzing cultural preference trends on a world-wide scale; parallel people's choices to public opinion (e.g., selection percentage between two fruits, actors or presidential candidates); media selection based on demographics of selectors, or use in evaluating people's preferences as a function of time of day (local time).

The method of the present invention also contemplates allowing an individual to compare their media selections with other individuals as a social networking tool. For example, a person may create a profile on a website. The individual may be allowed to list demographic information such as age, gender, location, race, ethnicity, or any other characteristic that may be utilized to categorize the individual. Through using computer algorithms to find commonality in selections, individuals have the ability to find who, out of a specified group of people, has answered most or least similar to them. It is contemplated that the individual may then find other individuals belonging to similar demographic categories and who have selected similar media. This style of matching between individuals is based on the degree of similarity of media selection percentages of different individuals. Such matching only indicates that they have similar or different tastes in the particular media viewed. This matching is based exclusively on the degree that another individual has selected media similar to him or her.

In another embodiment, the various media may have significance in determining a person's personality. While it is not an intention of this invention to enable psychological analysis, some media may resemble well-known inkblot test images to determine some personality characteristics. By selecting certain media, it is possible to capture the viewer's unconscious thoughts and thereby create a personality profile such that individuals may be matched based on mapping their personalities through their selections of similar or dissimilar media. One or more computer algorithms may then be used to match individuals with compatible personalities (though the personalities may be starkly different).

In creating a profile, the individuals may be allowed to include personal photos and personal descriptions. In some embodiments of the present invention, individuals may be enabled to contact one another directly, while in other implementations individuals may only contact each other indirectly through a specific interface.

It is contemplated that the source of the media will largely come from individuals or companies, but may also be generated in other ways. Media will normally be submitted to be evaluated by other individuals. The individual who submits the media as well as others are permitted to observe the relative success (selection percentage) of the media. It is also contemplated that the media may be presented to particular topic groups. For example, media pertaining to animals may be presented to groups of individuals with an interest in animals and media pertaining to automobiles may be presented to individuals with an interest in automobiles.

In one embodiment of the present invention, individuals may be allowed to participate in online evaluations by joining specific evaluation groups. When individuals join an evaluation group, they may request to evaluate media pertaining only to a specific topic group, or may opt to include all topic groups at once in their evaluation. Individuals may also opt out of any specific topic group or a number of topic groups. It is also contemplated that the evaluators in some embodiments may be able to provide comments to the person, group, company, or organization that submits a given medium for evaluation.

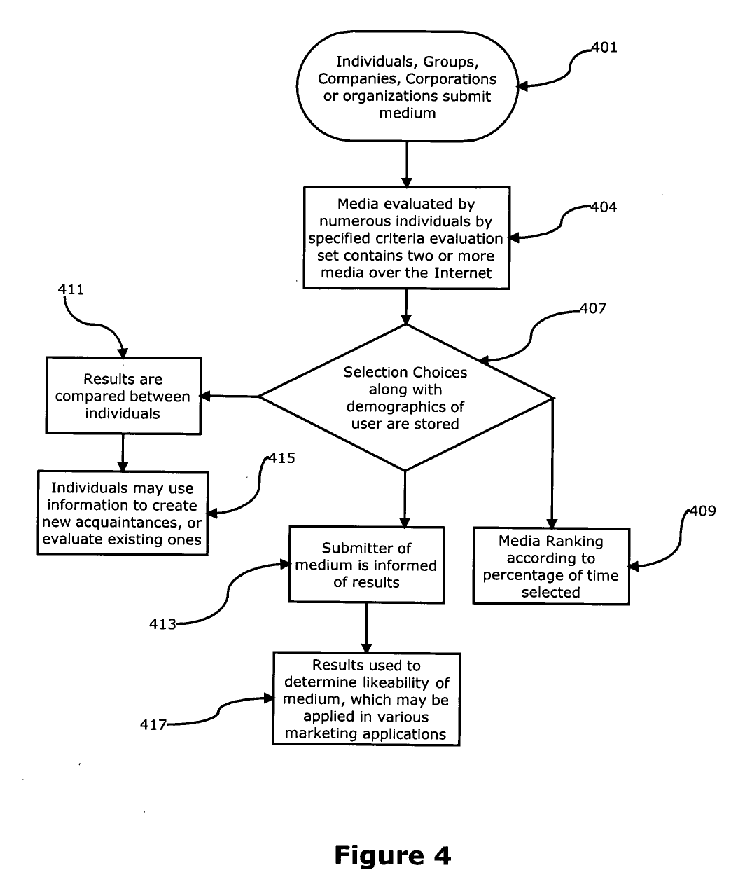

The present invention allows individuals to evaluate media created by them or others. Companies or other groups may also evaluate media created by their employees, consultants, or others at the company's request. FIG. 4 illustrates another implementation of the present invention where in a first step 401 individuals, groups, companies, corporations or organizations submit a medium. In the next step 404, the media is evaluated by numerous individuals by specified criteria evaluation sets that contain two or more media over the internet. In the following step 407, the selection choices along with demographics of the individuals are stored and the results may be utilized in either ranking media 409, comparing selections between individuals 411, or to inform the individual, organization, or company testing the medium of the results 413. When the results are compared between individuals 411, the selections may be utilized by those individuals to create new acquaintances or evaluate existing ones 415. When the submitter is provided with the results 413, it may utilize those results to determine the likeability of the medium and its use in marketing applications 417.

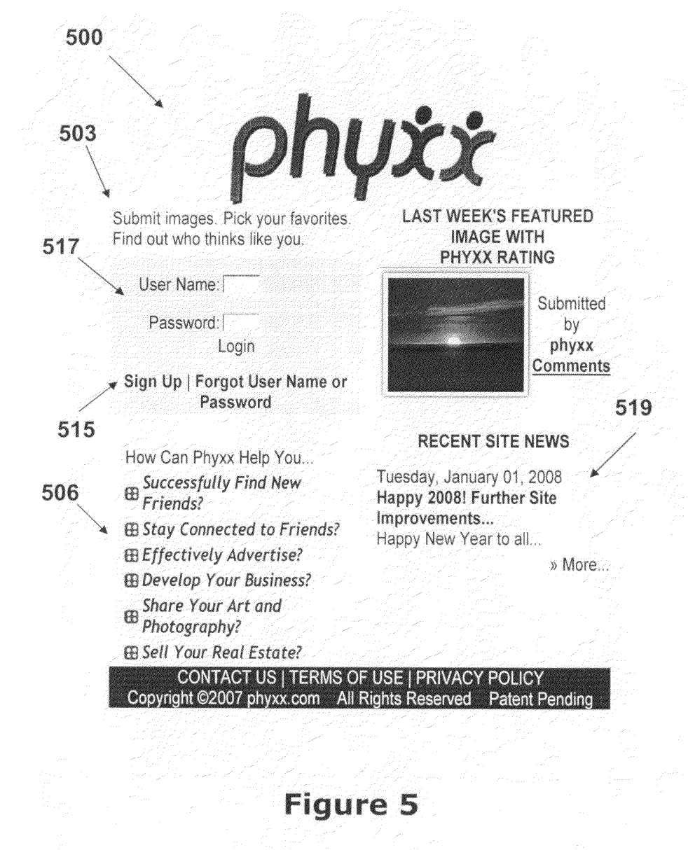

One example of the present invention is implemented into a website with the following structure. A main page 500 as shown in FIG. 5, containing a description of the service the website provides 503, the philosophy and functionality of the site 506, future plans, and fee schedules. The main page 500 may also include a link to sign up for a member account 515 and an area to log in 517 if they have already created and account. The main page 500 may also include current site news 519 and/or promotions. In addition, disclaimers and copyright notices may also be included in the main page. It is contemplated that one skilled in the art may design the webpage in any particular configuration and the example presented herein is not critical to the functionality of the present invention.

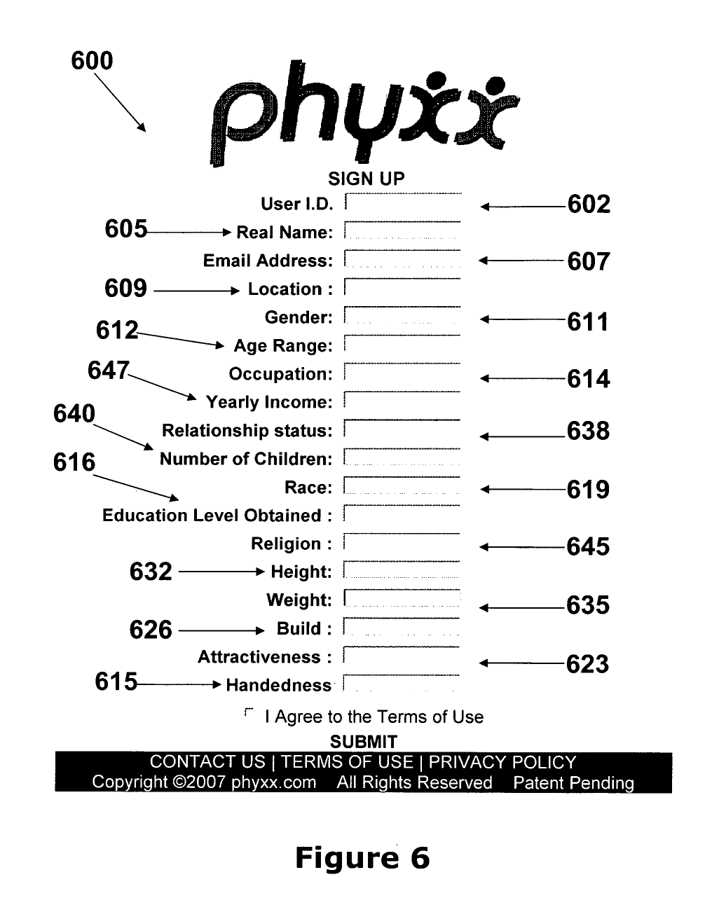

The link to sign up for a member account 515 leads the user to an account sign up page 600 as shown in FIG. 6. At the sign up page, the user may be provided with standard sign up options to include information such as user name 602, real name 605, e-mail address 607, location 609, gender 611, age range 612, occupation 614, handedness 615, education 616, race 619, attractiveness 623, build 626, height 632, weight 635, marital status 638, number and year birth of children 640, religion 645, income level 647, and other options selected by the person designing the web site. It is contemplated that answers to these questions may be typed, selected from pull down menus, or selected from multiple choice options. In addition to requests for information, the sign up page may also include standard information such as privacy policy, a statement that any information will only be released for statistics and is not ever provided in association with the individual's user name or real name, and precautions to exclude obscene user names. The sign up page may also state that all information is required but that only some information may be available to other users in the site. For example, such a statement may read, “All information is required, but information other than general location, gender and year of birth is not displayed to anyone except in bulk. General location, gender, and year of birth are available to other users on the site.” It is contemplated that in some embodiments of the present invention all the information will be required, in other embodiments only certain or no identifying information may be required.

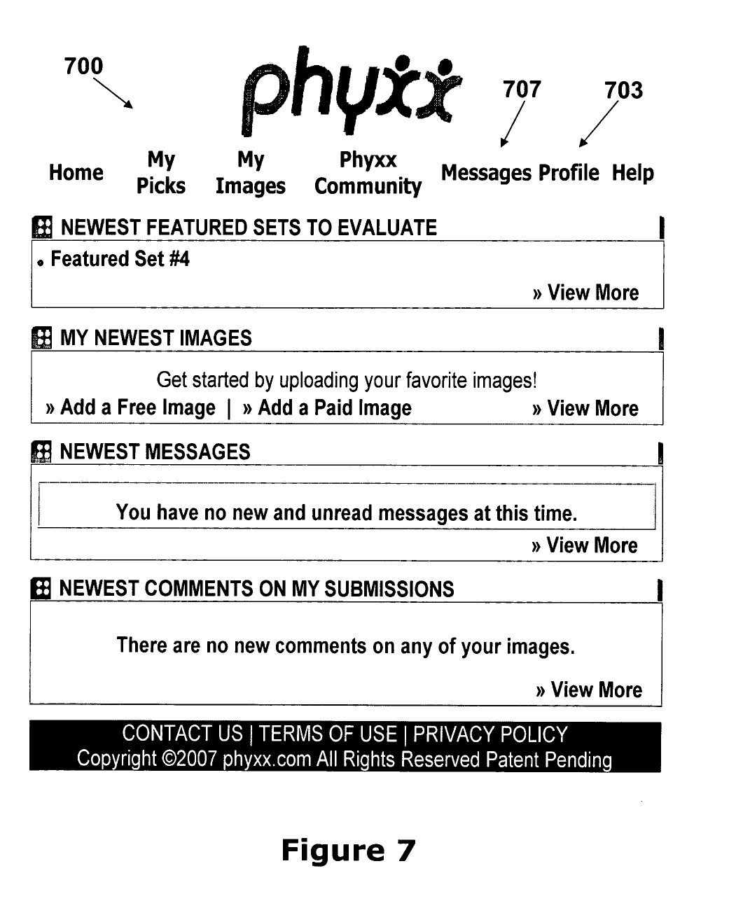

Users that already have an account and log in at the main webpage 500 will be directed to the member's page 700 as illustrated on FIG. 7. At the member's page 700, the user may be able to update any information on their profile 703, including their e-mail address. In some embodiments, the user may be required to verify their account if he or she is changing the e-mail address associated with the account. The user may also view personal evaluation statistics on how many picture sets they have evaluated since they created the account or for a specified period of time such as in the last month, last week, last day or for a specified period selected by the user. The user may also be provided with submission media selection statistics, where the user may be able to monitor evaluation of content submitted by that specific user, such as the media selection percentage and any comments provided by people who have evaluated the user's media if such option has been provided.

The member's page 700 may also include information about the user's connections, contacts, or friends. For example, the member's page 700 may contain an area to evaluate who the user has selected as having either most or least similar attributes. The user may be able to classify their selections based on demographic information provided such as age range, gender, general location, or other identifying characteristics. The user would be able to compare the results from a selected individual. In some embodiments, the results may be ranked and the last login time of the individual selected may be displayed. The user may be given an option to compare media selection percentages from particular categories.

The member's page 700 may also include an area for a list of “friends” with the possibility of showing or hiding the list (or specific individuals) to others. A “groups” list may also be available, containing a list of other people with some commonality. The member's page may also allow other individuals to leave private messages for the user 707, including requests for further information.

The user can upload media onto the site. In some embodiments of the present invention, it is contemplated that media will be associated/tagged with the user that submits it. A log of the media submitted by a user may be created and available to that user to maintain a record of images submitted. In some embodiments of the present invention, the users will be limited to upload one image/medium at a time in order to avoid and discourage mass, frivolous uploads. The user may have the option to submit an image either to a specific sub-group, or to larger groups.

It is contemplated that media may be uploaded in many different formats. In some embodiments of the present invention, however, the user may be limited to a specific format with specific requirements. For example, the user may be required to submit media in JPEG format, configured to allow automatic reformatting within the site, and converted to similar resolution and size. In some embodiments, the media may be required to be greater than 400-500 pixels in one direction (vertical or lateral), and less or equal on the other. Media may be optimized to take up approximately one quarter (¼) of screen area in a typical browser 1280×1024 resolution. The media may be automatically formatted and the submitter may have the ability to review the media upon submission. The user may also specify the category in which the medium belongs and keywords to describe it.

In some embodiments, the medium is not displayed on the site until an administrator approves it. Administrator approval may not be required in other embodiments of the present invention. The administrator may deny posting if the medium is pornographic, excessively violent, vulgar, redundant of another image, violates the law, or for any other reason the particular site hosting the service provides. In some embodiments of the present invention, the medium may not contain phone numbers, social security numbers, email addresses, credit card information, or any other information that may be deemed private. Each submission may be assigned a unique submission identification number (USIN).

Once the media is uploaded onto the site it may be presented to multiple users for evaluation. In one embodiment, the website may include a “featured graphics” option, where a set of 50 to 100 scenarios are available to all users. Users are encouraged to continuously evaluate all scenarios each week. Each scenario may consist of four pictures or media for the user to evaluate. Users may then select a category or categories that they would like to review. In some embodiments, each category will include the number of pictures available for evaluation in that specific category. The categories may include humor, black and white, artwork, nature, solitary objects, human faces, animals, cartoons, cars, cell phone shots, events, people (outside of human face), and others as desired by the users and available on the web site.

Once the categories are selected, the list of all active USINs within the categories are tabulated and assigned placeholder numbers. A random number generator produces a list of placeholder numbers, in some embodiments up to 1,000 placeholder numbers are generated. After the placeholder numbers are identified and assigned, the user is presented with a first set of media containing, for example, four pictures. After the user makes his or her selection, the next four pictures are presented until all the media is presented to the user and all selections are made. Once all the media is presented, the user may be asked whether he or she would like to continue evaluating other media.

In one embodiment of the present invention, as shown on FIG. 3, four images are displayed on different quadrants of the screen with a white background. The user may select the picture by clicking on his or her selection. At the top and bottom of the screen there may be a link that allows the user to end the evaluations and return to the main page. Every time a selection is made, the four USINs are written to the user's log file, with identification of whether they selected an image or not. At the same time, master statistics are continuously refreshed for each USIN. The USIN statistics for each medium provide the media selection percentage for that specific medium. In addition to the selections, there may be an option to post short comments to the individual submitting the medium. Comments may be provided for any medium, even if the evaluator did not select it.

In some instances, there may be limits on the number of media that a specific individual may maintain on each category. The limitations may be based on a number of factors, such as the number of media maintained, the number of live submissions the submitter has and others. In addition, the user may have a log file that includes information relating to his or her profile, such as list of friends and groups; list of choices for each medium they have evaluated; last login time, user name, email information, signup information, profile information; list of graphics they have submitted; comments on graphics they have submitted; comments the user has received.

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

What is claimed is:

1. A method of determining a user's preference for evaluating media, said method comprising the steps of:
a) presenting a set of media to an individual, the set containing a plurality of media elements;
b) providing an evaluation criterion to the individual based on a plurality of selected characteristics;
c) allowing the individual to select at least one element from the set of media based on the criterion provided; and
d) repeating steps a) through c), as necessary, to establish a subjective ranking of media elements that said individual prefers.

2. The method of claim 1, wherein the set of media is selected from the group consisting of randomly and non-randomly selected media.

3. The method of claim 1, wherein the media is selected from the group consisting of words, phrases, sentences, photographs, paintings, computer generated graphics, manually drawn graphics, video, and sound clips.

4. The method according to claim 1, wherein none of said sets of media are repeated between consecutive steps.

5. The method according to claim 1, wherein at least one of said media elements is repeated in said sets of media between consecutive steps.

6. The method according to claim 1, wherein none of said media elements is repeated in said sets of media between consecutive steps.

7. The method according to claim 1, wherein said sets of media are selected to maximize differentiation between each element in said set of media.

8. The method according to claim 1, further comprising the steps of:
e) calculating a selection percentage of media elements that said individual prefers.

9. The method according to claim 8, wherein the selection percentage corresponds to the number of times a particular media element is selected compared to the total number of individuals that were presented with the particular media element in a media set and/or the number of times the media set was presented.

10. The method according to claim 8, further comprising the steps of:
f) selecting a particular media element based on the element's selection percentage.

11. The method according to claim 1, wherein said method is performed over a global computer network.

12. The method according to claim 1, wherein said method is performed via a computer website.

13. The method according to claim 1, wherein said sets of media elements are presented on a two-dimensional or three-dimensional array.

14. The method according to claim 13, wherein said array comprises a computerized graphic user interface.

15. The method according to claim 14, wherein said computerized graphic user interface is displayed in a location selected from the group consisting of:
in-store retail terminals;
retail internet websites;
personal computers
televisions; and
mobile phone handsets.

16. A method of matching individuals to compatible individuals using media selection, said method comprising the steps of:
a) presenting a set of media to an individual, the set containing a plurality of media elements;
b) providing an evaluation criterion to the individual based on a plurality of selected characteristics;
c) allowing the individual to select at least one element from the set of media based on the criterion provided;
d) repeating steps a) through c), as necessary, to establish a subjective ranking of media elements that said individual prefers;
e) establishing a personality profile for the individual based on said individual's selection of media elements; and
f) matching the individual to another compatible individual based on the personality profile.

17. The method of claim 16, wherein the set of media is selected for its significance in determining a person's personality.

18. The method according to claim 17, wherein said method create a personality profile such that individuals may be matched based on mapping their personalities through their selections of similar or dissimilar media.

19. The method according to claim 16, wherein said method is performed over a global computer network.

20. The method according to claim 16, wherein said method is performed via a computer website.
